(19) United States
(12) Patent Application Publication
(10) Pub. No.: US 2026/0370559 A1
(43) Pub. Date: Nov. 19, 2026

(54) SYSTEMS AND METHODS FOR PREDICTING BURST TRAFFIC AT A SERVER USING SCALABLE CLIENT INTERACTION ANALYSIS

(71) Applicant: Verizon Patent and Licensing Inc., Basking Ridge, NJ (US)

(72) Inventor: Haripriya SRINIVASARAGHAVAN, Plano, TX (US)

(73) Assignee: Verizon Patent and Licensing Inc., Basking Ridge, NJ (US)

(21) Appl. No.: 19/206,458

(22) Filed: May 13, 2025

(51) Int. Cl. H04L 41/147; H04L 43/0876

(52) U.S. Cl. CPC H04L 41/147; H04L 43/0876

(57) ABSTRACT

In some implementations, a computing device may obtain interaction data that is based at least in part on a set of client devices interacting with a server during a testing duration, the set of client devices associated with a first quantity of client-server interactions with the server. The computing device may process the interaction data to determine one or more clusters of client interactions that occur within a same time interval of the testing duration, each cluster of the one or more clusters being a respective potential high traffic load. The computing device may compute one or more traffic characteristics for each cluster of the one or more clusters. The computing device may generate a predicted second quantity of client-server interactions with the server using the one or more traffic characteristics, the second quantity being larger than the first quantity.

### BACKGROUND

Interconnected systems are computing architectures that facilitate communication and data exchange between multiple components, enabling the scaling of resources (e.g., computing power, storage capacity, and network bandwidth) to allow numerous client devices to access and utilize centralized services. Examples include cloud-based services, distributed databases, and large-scale web applications, often employing a client-server architecture where a server processes requests from multiple client devices and sends appropriate responses.

### BRIEF DESCRIPTION OF THE DRAWINGS

FIGS. 1A-1F are diagrams illustrating an example implementation of predicting burst traffic at a server using scalable client interaction analysis.

FIG. 2 is a diagram of an example environment in which systems and/or methods described herein may be implemented.

FIG. 3 is a diagram of example components of a device associated with predicting burst traffic at a server using scalable client interaction analysis.

FIG. 4 is a flowchart of an example process associated with predicting burst traffic at a server using scalable client interaction analysis.

### DETAILED DESCRIPTION OF EXAMPLE EMBODIMENTS

The following detailed description of example implementations refers to the accompanying drawings. The same reference numbers in different drawings may identify the same or similar elements

In a client-server architecture, a system may be divided into two main components: clients and servers. Clients are devices or applications that request services or resources. Examples of clients may include web browsers, mobile apps, desktop applications, or the like. Servers are computers or software systems that provide these services or resources. Examples of servers may include web servers, database servers, application servers, or the like. To illustrate, a client may send a request to a server over a network, such as a request to access data or a request to perform a task. The server may process the request, perform the necessary operations, and/or send a response back to the client. The use of a client-server architecture allows for centralized management of resources and services, enabling multiple clients to access and utilize the server's capabilities simultaneously.

In some cases, how client applications are implemented may lead to scalability issues in the client-server architecture. For instance, various client applications and/or client devices may be implemented to perform certain actions simultaneously, potentially resulting in multiple clients making service calls at the same absolute time or in response to specific external events. Examples of such actions include multiple client devices each refreshing a respective data cache at a predetermined absolute time, fetching new content or updates when a shared event occurs (e.g., an expiration of a program or a promotional offer), or retrying failed requests at fixed intervals. Other scenarios include calls made at the same absolute times and not staggered, retries that happen after the same interval after a failure, or calls tied to an external event (e.g., a new catalog title or a call made as a response to a notification). These actions may result in synchronous or burst traffic (e.g., sudden spikes in traffic volume) at the server. At times, bursts of traffic may have a volume that overwhelms resources at the server, leading to degraded performance or even service outages.

“Burst traffic” (also referred to as a hotspot) may be characterized by a significant surge in backend calls to a server within a short time window (e.g., within a few seconds to within a few minutes). Burst traffic may manifest in various forms, including multi-client burst traffic types, single-client burst traffic types, and global burst traffic types. Multi-client burst traffic (e.g., a multi-client hotspot) may occur when a large number of backend calls from different clients target a same application programming interface (API) or endpoints simultaneously, leading to a sudden spike in server load. Single-client burst traffic (e.g., a single-client hotspot) may arise when a single client generates a high volume of backend calls within the short time window, which may indicate issues such as runaway calls or improper error handling. Global burst traffic (e.g., a global hotspot) may involve a substantial number of backend calls from different clients across multiple APIs or endpoints within the short time window. Multi-client, single-client, or global burst traffic may be one-time events, such as a million API requests at the start of a widely viewed event (e.g., The Super Bowl or World Cup finals), or may be cyclic events in which bursts of traffic occur at regular intervals. An example of cyclical burst traffic may include 5000 requests per second every four hours.

As one example of burst traffic, clients of a video delivery product may fetch program information (e.g., program titles, thumbnails/images, descriptions, metadata such as genre, release date, duration, and ratings, streaming links, availability status, user-specific data for personalized recommendations, and promotional information) to populate a browsing rail or a browsing carousel. In some cases, the clients may be designed to fetch program information from the service based at least in part at the time of expiration of a program, which may result in synchronization and burst traffic from multiple client devices reaching the end of a program at the same time, resulting in the server being overwhelmed and unable to handle the sudden spike in requests efficiently. As another example, a movie reservation app may be designed to fetch a new set of movie ticket prices from a server based at least in part on expiration of an existing price reduction. In a similar manner to the video delivery product, all clients may send out a request to fetch new prices contemporaneously, resulting in burst traffic and congestion at the server.

Some server architectures may use auto-scaling solutions that dynamically allocate resources to mitigate bursts of traffic. However, the auto-scaling solutions may be too slow to respond to sudden and brief spikes in demand associated with burst traffic. Alternatively, or additionally, a server provider may use pre-production testing environments with a sample set of client devices to detect and mitigate scalability issues. The server provider may also use performance and scale testing to simulate the supported number of transactions and test if the server is able to perform as per the service level agreement for the simulated transactions. However, in some cases, the pre-production testing environment as well as the performance or scale testing may fail to detect issues associated with burst traffic. For instance, the pre-production setup may use a sample set of 20 to 30 client devices to simulate normal operations, and the scale of the sample set may not reveal burst traffic issues that would occur at a larger scale. While simulating the API transactions per second for performance and scale testing, the simulation may not capture or be able to estimate an actual magnitude of the burst traffic that will occur based at least in part on the smaller sample of client devices (e.g., relative to a quantity of client devices in deployment) that may not capture a full scale of burst-traffic. An example scenario includes a video delivery system in which clients may be designed to fetch new content simultaneously when a program expires. During actual deployment, the server may communicate with millions of devices that generate burst traffic from a synchronized activity, and may overwhelm server resources before auto-scaling mechanisms have time to respond. Such a scenario may not be captured in a test environment based at least in part on a smaller sample of client devices exhibiting smaller amounts of traffic relative to a deployment scenario. The lack of scalability in pre-production testing and the inability to timely respond with auto-scaling may lead to degraded performance or service outages.

Some implementations described herein provide a method for predicting and managing burst traffic in a client-server architecture to enhance system scalability and optimize performance. Some implementations more specifically relate to predicting burst traffic at a server using scalable client-server interaction analysis. In some aspects, a computing device may obtain interaction data based on a set of client devices (e.g., a sample set) interacting with a server during a testing duration. The set of client devices may be associated with a first quantity or first scale of client-server interactions with the server. The computing device may process the interaction data to determine one or more clusters of client interactions that occur within a same time interval of the testing duration. In some cases, the computing device may identify each cluster as a respective potential high traffic load. Based at least in part on identifying the clusters of client interactions, the computing device may compute one or more respective traffic characteristics for each cluster of the one or more clusters, and may generate a predicted second quantity or a second predicted scale of client-server interactions with the server using the traffic characteristics. As an example, the computing device may generate a predicted second quantity or second scale of client interactions that is larger than the first quantity or the first scale of client-interactions with the server captured and associated with the set of client devices.

By analyzing interaction data based on a set of client devices to identify potential high traffic loads, the described techniques can be used to proactively detect and mitigate burst traffic patterns before they occur in a production environment. That is, the analysis of the interaction data may result in the identification of design-induced burst traffic issues that may not be evident in smaller-scale pre-production testing. For instance, a computing device may use sample interaction data to predict any combination of an intensity of burst traffic, a periodicity of burst traffic, and a potential impact of burst traffic on server performance metrics (e.g., a response latency time and/or data throughput). In some cases, the described techniques provide a predictive model for system behavior under elevated traffic conditions, and enable preemptive optimization of server configurations and resource management, ensuring that server resources are adequately provisioned to handle peak loads without degradation in performance or service outages. Additionally, or alternatively, the ability to detect and predict burst traffic patterns enables more efficient use of auto-scaling solutions by allowing them to be triggered in advance of anticipated traffic spikes, thereby improving the overall reliability and scalability of the client-server architecture. A proactive detection and management of burst traffic patterns may result in more robust system designs, enhanced resource conservation, and increased compliance with service level agreements (SLAs).

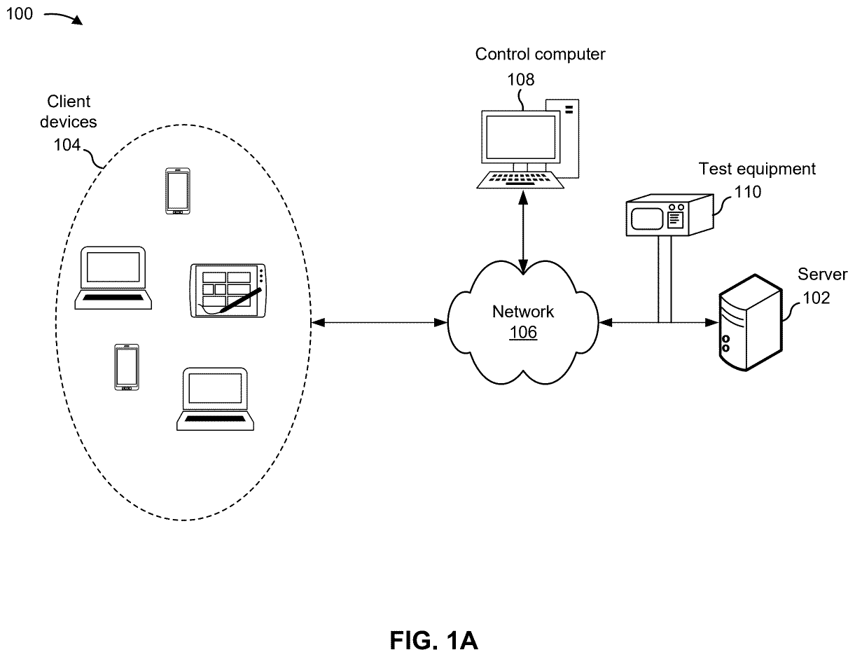

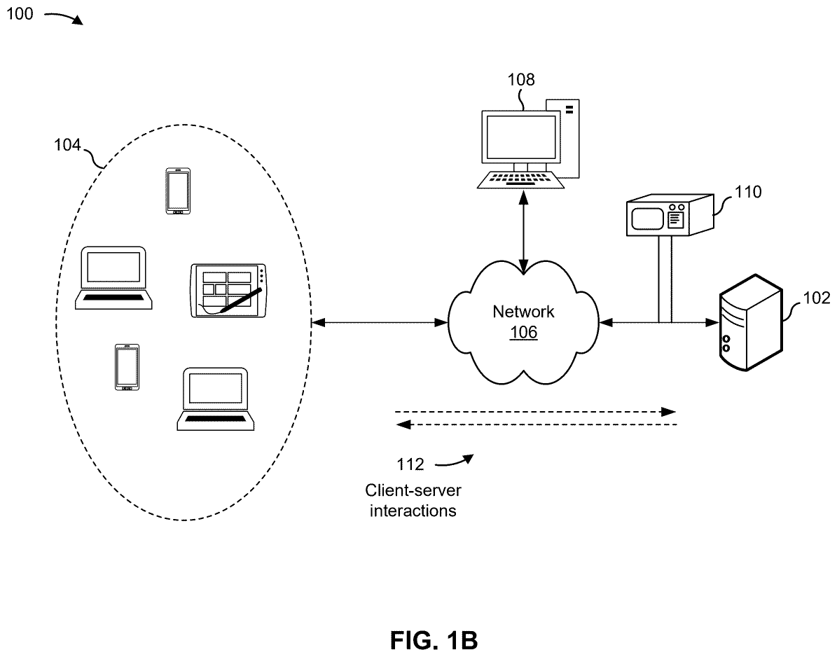

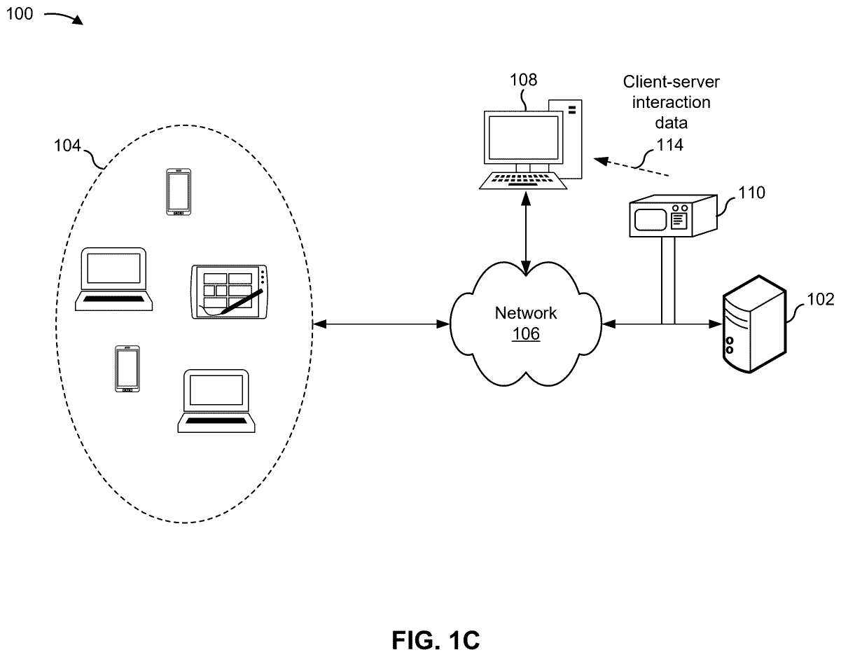

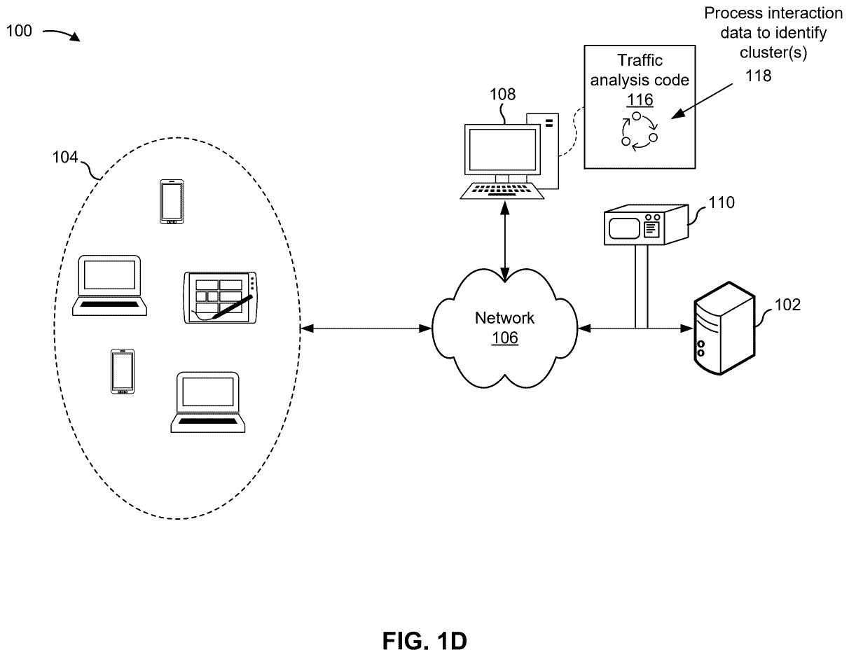

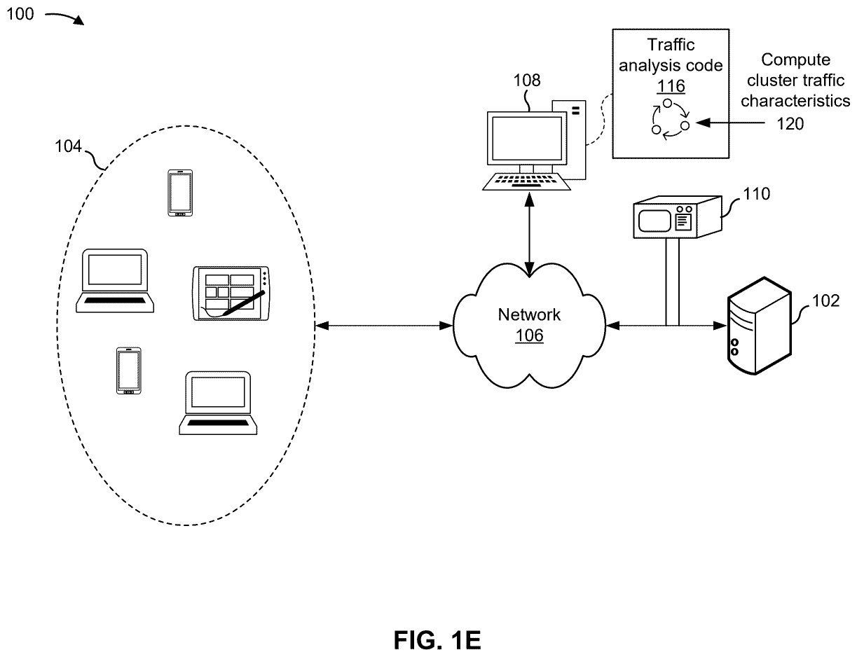

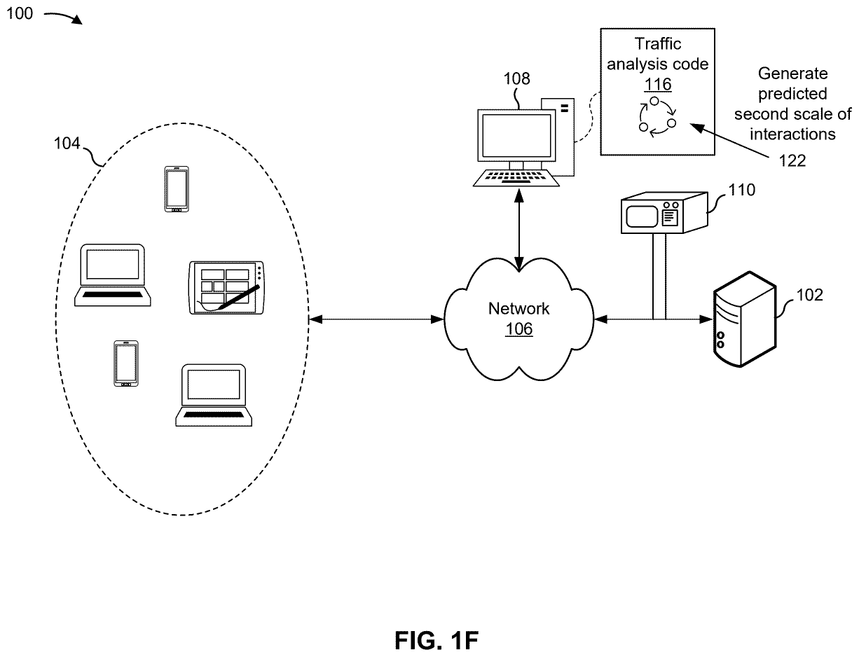

FIGS. 1A-1F are diagrams illustrating an example implementation 100 of predicting burst traffic at a server using scalable client interaction analysis.

As shown in FIG. 1A, the example implementation 100 includes a server 102 and multiple client devices 104 that are connected to the server 102 via a network 106. The client devices 104 may include various types of computing hardware such as mobile phones, tablets, laptops, smart TVs, desktop computers, internet of things (IoT) devices, and other internet-connected devices. The client devices 104 may interact with the server 102 via the network 106 to request and receive services, such as video streaming, data retrieval, and application updates. In some aspects, the client devices 104 may be a sample set of client devices that are used in a test environment and/or a quality assurance (QA) environment that is designed to simulate real-world usage and evaluate the performance, scalability, and reliability of the server 102. The network 106 may encompass one or more communication infrastructures, including the Internet, one or more local area networks (LANs), and/or wireless networks such as Wi-Fi and cellular networks. In some aspects, the client devices 104 may generate various types of network traffic, including hypertext transfer protocol (HTTP) and hypertext transfer protocol secure (HTTPS) requests for web services, API calls for data access, real-time streaming protocol (RTSP) for video delivery, and message queuing telemetry transport (MQTT) for IoT devices. For instance, a mobile phone might send an HTTP request to fetch video metadata, while a smart TV might use RTSP to stream video content.

The example implementation 100 also includes a control computer 108 and test equipment 110. In some aspects, the control computer 108 may be a QA (quality assurance) control computer that monitors and analyzes the interactions between the client devices 104 and the server 102 to detect and predict burst traffic patterns, assess system performance, and identify potential scalability issues. The control computer 108 may be communicatively coupled to any combination of the server 102, the client devices 104, and the test equipment 110 via the network 106. The test equipment 110 may be, or integrate with, any combination of tools and devices used to simulate client interactions, capture network traffic, and/or log API calls, such as a network analyzer, a backend logging system, or other diagnostic tools that help in gathering and analyzing interaction data for QA purposes. In some cases, the test equipment 110 may include at least some functionality of a computing device (e.g., processing power to run simulations, storage capacity to log interaction data, and network interfaces to capture and analyze network traffic. In a similar manner as the control computer 108, the test equipment 110 may be communicatively coupled to the server 102, the client devices 104, and the control computer 108 via the network 106. In some aspects, the control computer 108 may be configured to monitor, analyze, and predict traffic patterns and system performance, while the test equipment 110 may be configured to capture network traffic (e.g., client-server interactions), and provide the captured network traffic to the control computer 108.

While the example implementation 100 includes the client devices 104 as a sample set of client devices, other examples may not include the client devices 104 and may instead use the test equipment 110 to simulate client device interactions. For instance, the test equipment 110 may generate various types of network traffic, such as HTTP/HTTPS requests, API calls, and streaming requests, to mimic a deployment environment and/or production environment of the server 102 that includes the client devices 104. That is, the test equipment 110 may simulate the behavior and interactions of multiple client devices to create a load on the server 102. Alternatively, or additionally, as described above, the test equipment 110 may capture and log interaction data.

As shown by FIG. 1B, the client devices 104 and the server 102 may communicate with one another via the network 106 (shown by FIG. 1B as client-server interactions 112). As described above, the client-server interactions 112 may include various types of network traffic, such as HTTP/HTTPS requests for web services, API calls for data access, streaming requests using protocols like RTSP, and messaging protocols such as MQTT for IoT devices. The test equipment 110 may be configured to log these client-server interactions 112 and/or capture detailed information about the requests and responses exchanged between the client devices 104 and the server 102. Examples of detailed information may include, for each communication or interaction, any combination of a timestamp, a request header, a request body, a response time, and/or other relevant data. In some cases, the client devices 104 may be a sample set of client devices that are configured with different types of clients/devices to mimic a deployment environment or production environment of the server 102. Alternatively, or additionally, the test equipment 110 may be configured to simulate different types of clients/devices to mimic a deployment environment or production environment of the server 102.

In some aspects, the test equipment 110 may be, or integrate with, a network analyzer or a backend logging system that monitors and logs interactions by integrating with the network 106, the server 102, and the client devices 104. For instance, the test equipment 110 may have one or more physical connections to network switches and routers, or may use one or more software agents that are installed on the server 102 the client devices 104, or both. The test equipment 110 may utilize packet sniffing tools that intercept and analyze data packets to capture real-time network traffic and log the interactions. The test equipment 110 may be configured capture any notifications from the services to these devices, as received by the client devices 104.

In some aspects, the client devices 104 may be configured to perform routine customer operations and background operations over an extended period of time (e.g., a week or month), such as browsing, searching, streaming videos, making purchases, data synchronization, cache updates, and periodic data fetching. During the extended period of time, the test equipment 110 may capture the client-server interactions associated with the client devices 104. Alternatively, or additionally, the test equipment 110 may generate and receive simulated network traffic to mimic the behavior of client devices 104. For instance, the test equipment 110 may generate synthetic requests and responses that replicate the patterns and loads observed historically in a production environment. By doing so, the test equipment 110 may create a traffic load on the server 102 that simulates the deployment environment and/or production environment. The simulated traffic may be customized to include specific types of interactions, such as periodic API calls, bulk data transfers, and high-frequency streaming requests, to thoroughly test the server's performance and resilience under different conditions. Alternatively, or additionally, the test equipment 110 may be configured to simulate routine customer operations and background operations over an extended period of time (e.g., a week or month). During this simulation, the test equipment 110 may capture the client-server interactions associated with the simulations.

As shown by FIG. 1C, the control computer 108 may obtain client-server interaction data 114 from the test equipment 110. To illustrate, the control computer 108 may periodically and/or iteratively query the test equipment 110 for the client-server interaction data 114, which may include information about the client-server interactions 112 described with regard to FIG. 1B, such as timestamps, request headers, request bodies, response times, and other relevant metrics. Additionally, or alternatively, the control computer 108 may receive user input to initiate data retrieval, or may detect a trigger event that prompts the control computer 108 to query the test equipment 110 for the client-server interaction data 114. In some cases, the test equipment 110 may be configured to periodically push the client-server interaction data 114 to the control computer 108 (e.g., without receiving a request). The client-server interaction data 114 may be collected over a testing duration. That is, the client-server interaction data 114 may be a log of interactions that occur within the testing duration. As described above, the control computer 108 and the test equipment 110 may communicate with one another via the network 106. The client-server interaction data 114 may be a first quantity or a first scale of client-server interactions with the server 102 (e.g., a first quantity or a first scale of client-server interactions that are based at least in part on the client devices 104).

As shown by FIG. 1D, the control computer 108 may include traffic analysis code 116. As one example, the control computer 108 may include a central processing unit (CPU) that executes processor-executable instructions, and the traffic analysis code 116 may be implemented based at least in part on a set of predefined algorithms and models that are implemented via processor-executable instructions. In some cases, the traffic analysis code 116 may be implemented using a static algorithm, an artificial intelligence/machine learning (AI/ML) algorithm, or both. Static algorithms may include predefined rules and heuristics for detecting traffic patterns that remain constant (e.g., predefined rules that are based on computations as described below and/or predefined rules that do not change), while AI/ML algorithms may be trained to process interaction data based at least in part on historical interaction data. For example, an AI/ML model may be trained using a sample set of historical interaction data to recognize and predict patterns of burst traffic and other anomalies in client-server interactions. To illustrate, the model may be provided with labeled training data, also known as ground truth data, which includes examples of both normal and burst traffic patterns. During the training process, the model may receive feedback on predictions generated by the model, enabling the model to adjust and improve an accuracy in identifying and predicting burst traffic and other anomalies. Examples of AI/ML models include decision trees for classifying traffic patterns, neural networks for identifying complex interaction patterns, time-series analysis techniques for predicting cyclicity, trend and other patterns, and clustering algorithms for detecting groups of similar interactions that may indicate potential high traffic loads.

As shown by reference number 118, the traffic analysis code 116 may be configured to process the interaction data to identify one or more clusters of client interactions. As one non-limiting example, the traffic analysis code 116 may order the client-server interactions included in the interaction data by respective timestamps and event types. For instance, the traffic analysis code 116 may order the interactions by timestamp (e.g., in sequential order, oldest to newest). Alternatively, or additionally, the traffic analysis code 116 may group interactions by event type, and order the group of event-type interactions by timestamp. For example, the traffic analysis code 116 may group interaction data that is a fetch request event type, and may order the grouped fetch request interactions by respective timestamps to identify patterns or clusters of fetch requests.

Based at least in part on ordering the client-server interactions (e.g., by timestamp and/or event type), the traffic analysis code 116 may identify clusters of client interactions that occur within the same time interval, alternatively referred to as a time bucket. To illustrate, the traffic analysis code may partition the testing duration of the client-server interaction data into multiple time intervals or time buckets, of 1 minute duration each, and may group client interactions that occur within the same time interval. To group client interactions into a respective time interval, the traffic analysis code 116 may round the respective timestamp of each client interaction to the nearest time interval and group the client interaction into a cluster that is associated with the nearest time interval. Additionally, the traffic analysis code 116 may identify clusters of the same kind of requests (e.g., API calls with similar parameters) from more than one device occurring within a short duration (e.g., within a 2-minute interval). These clusters may indicate a concentration of requests to the server within a specific time interval (e.g., a hotspot) or burst activity for further analysis.

In some cases, the traffic analysis code 116 may classify a cluster as a potential high traffic load (e.g., a quantity of traffic or interactions that satisfies a high traffic threshold). For instance, the traffic analysis code may compute or analyze a quantity of client interactions within a cluster and compare the quantity to a predefined traffic load threshold. Computing the quantity of client interactions may include computing a total quantity of client interactions (e.g., of all event types), computing a quantity of event-specific client interactions, or both. Based at least in part on the quantity of client interactions in the cluster satisfying or exceeding the traffic load threshold, the traffic analysis code 116 may classify the cluster as a potential high traffic load. Burst traffic identified by the traffic analysis code 116 as being a potential high traffic load may also be flagged or reported by the traffic analysis code 116 for further analysis.

Alternatively, or additionally, the traffic analysis code 116 may analyze request data within the interaction data to classify clusters based on additional parameters, such as device information and account information. Device information may include details about the client device, such as device type, operating system, or unique identifiers, while account information may encompass user-specific data like a user identifier or subscription level. By incorporating these parameters, the traffic analysis code 116 may identify multi-client burst traffic types, enhancing the precision of traffic pattern analysis and enabling targeted optimizations.

As shown by FIG. 1E and by reference number 120, the traffic analysis code 116 may compute one or more traffic characteristics of each cluster that is identified as a potential high traffic load. To illustrate, the traffic analysis code 116 may compute a burst density (D) of a cluster, where D is a metric that may be used to quantify a concentration of client interactions within a specific time interval. In some aspects, D may be defined as a ratio of a number of client devices sending relevant events (e.g., client interactions that have a same event type) within a same time interval (e.g., a same time bucket) to a total quantity or number of client devices used in a testing procedure (e.g., a quantity of client devices in the client devices 104). In some cases, burst density may be expressed as:

$$D = \frac{count ( events per time interval )}{C}$$

where C represents the total quantity of clients and each event is a client interaction of the relevant event type. A burst density value of D=1 indicates that all clients are sending the relevant event within the same time interval, resulting in a high-intensity burst (e.g., burst traffic that satisfies a high traffic threshold). To illustrate, in a scenario that includes 1 million client devices and a time interval of 1 minute, a burst density of 1 indicates that 1 million requests are sent within that 1-minute period. In a second scenario, a burst density value of D=0.5 indicates that approximately half of the client devices are sending the relevant event within the same time interval, resulting in burst traffic that is less dense and/or is less intense relative to the first scenario. Using the same number of client devices and time interval (e.g., 1 million client devices and a time interval or time bucket 1-minute, the second scenario indicates that the server may receive 0.5 million requests within the 1-minute period.

As at least part of computing the traffic characteristics of a cluster, the traffic analysis code 116 may identify a burst traffic type of the cluster based on the concentration and distribution of client interactions within the cluster. As an exemplary scenario, a testing environment may collect interaction data from C total client devices, where the C total client devices include at least two client devices: client device 1 (C1) and client device 2 (C2). The interaction data may span a testing duration, and the traffic analysis code 116 may partition the testing duration into four 1-minute time intervals (e.g., time interval 1 (t1), time interval 2 (t2), time interval 3 (t3), and time interval 4 (t4)) corresponding to 1-minute intervals at 3:00 PM, 3:25 PM, 4:00 PM, and 5:01 PM, respectively. That is, t1 occurs at 3:00 PM, t2 occurs at 3:25 PM, t3 occurs at 4:00 PM, and t4 occurs at 5:00 PM. The interaction data includes client interactions that are classified as at least a first event type (E1) and a second event type (E2), but may include more types of events. The traffic analysis code 116 may be configured with a burst density threshold (T) that is a percentage threshold and has a value of T=0.5.

The traffic analysis code 116 may identify or determine different burst types (e.g., different hotspots) based on a concentration and/or a distribution of client interactions within a specific time interval and/or a specific cluster. For instance, the traffic analysis code 116 may identify a single-client burst traffic type at t1 based at least in part on identifying that the event-specific interactions grouped in a first cluster that is associated with t1 originate from a same client device (e.g., C1) and satisfy or exceed a percentage threshold. As an example, the traffic analysis code 116 may compute a burst density for the first cluster, and may identify the burst traffic of the first cluster as a single-client burst traffic type based at least in part on:

$$D 1 = \frac{count ( E 1 , C 1 , t 1 )}{C} > T$$

where D1 is the burst density of the cluster associated with t1, the client interactions are of type E1 and originate from C1, and occur within t1. Alternatively, or additionally, the traffic analysis code 116 may identify a multi-client, single-event burst traffic type at t2 based at least in part on the client interactions within a second cluster that is associated with t2 being a same event type (e.g., E2), the client interactions originating from different client devices, and a burst density for the second cluster (D2) satisfying or exceeding the percentage threshold. That is:

$$D 2 = \frac{count ( E 2 , * , t 2 )}{C} > T$$

where * is a wildcard that indicates that the computation includes interactions from all client devices. As yet another example, the traffic analysis code 116 may identify a multi-client, multi-event burst traffic type at t3 based at least on analyzing the client interactions in a third cluster associated with t3. For instance, the traffic analysis code 116 may compute a burst density for the third cluster (Dmulti) for any type of event from any client device associated with the client interactions as follows:

$$Dmulti = \frac{count \text{(*} , * , t3 )}{C} > T$$

where the first * is a wildcard that indicates that the computation includes client interactions in the third cluster of all event types, and the second * is a wildcard that indicates that the computation includes all client interactions in the third cluster from all client devices. Based at least in part on the burst density Dmulti satisfying or exceeding the percentage threshold (the example above describing Dmulti exceeding the percentage threshold), the traffic analysis code 116 may identify the third cluster as being a multi-client, multi-event burst traffic type.

Alternatively, or additionally, the traffic analysis code 116 may compute various other traffic characteristics of the cluster(s). For instance, the traffic analysis code 116 may compute a time variance metric for the burst, sometimes referred to as a burst time variance, that measures a spread of interaction timestamps within a cluster and indicates a distribution of client interactions within the cluster (e.g., a cluster-based time variance metric). A burst time variance metric that satisfies a low variance threshold (e.g., a low time variance metric, such as 5 seconds) may indicate that the burst traffic is more synchronized, and a burst time variance metric that satisfies a high variance threshold and/or fails to satisfy the low variance threshold (e.g., a high time variance metric, such as 5 minutes) may indicate a more dispersed, less synchronized burst. In some cases, the traffic analysis code 116 may compute a peak transactions per second (TPS) for each cluster that indicates a highest rate of client interactions within the time interval associated with the cluster and may indicate a measure of a maximum load that the server may experience during the burst.

In some cases, the traffic analysis code 116 may use traffic characteristic(s), such as burst density and cluster-based time variance, to identify or compute burst traffic behavior. As an example, the traffic analysis code 116 may compute a periodicity of clusters and/or a cyclical pattern of burst traffic by analyzing burst density to determine the intensity of bursts and/or by computing a burst traffic time variance metric that measures the spread and consistency of burst traffic patterns (e.g., using multiple bursts of traffic that have a same interaction event type or a same burst traffic type) over multiple bursts of traffic. A burst traffic time variance metric may indicate how consistently burst traffic of a same interaction event time, or a same burst traffic type, occur and how spread out the bursts of traffic are over time, providing insights into the overall traffic behavior and potential future occurrences of burst traffic.

To illustrate, in one scenario, the traffic analysis code 116 may use a burst density threshold of T=0.3 to examine the occurrence of bursts at specific time intervals. In this scenario, the traffic analysis code 116 may process interaction data that includes client interactions from a first client device (e.g., C1), a second client device (e.g., C2), a third client device (C3), and a fourth client device (C4). Alternatively, or additionally, the interaction data includes at least two distinct event types (e.g., E1 and E2), and C represents a total quantity of clients that contribute to the interaction data (e.g., in the client devices 104). In a similar manner as described above, the traffic analysis code 116 may partition the interaction data into multiple time intervals, resulting in at least four 1-minute time intervals (e.g., t1, t2, t3, t4) that occur at 3:01 PM, 3:25 PM, 4:00 PM, and 5:01 PM, respectively. In computing the burst density for each time interval, the traffic analysis code 116 may compute the following burst densities:

$$B 1 = \frac{count ( E 1 , * , t 1 )}{C} > T$$

$$B 2 = \frac{count ( E 2 , * , t 3 )}{C} > T$$

$$B 3 = \frac{count ( E 2 , * , t 4 )}{C} > T$$

where B1 is the burst density for time interval t1, B2 is the burst density for time interval t3, and B3 is the burst density for time interval t4. Based at least in part on determining that the burst densities B1, B2, and B3 exceed the threshold T, the traffic analysis code 116 may determine that burst traffic has occurred at each respective time interval. That is, the traffic analysis code 116 may identify and confirm the presence of burst traffic during these specific time intervals, enabling further analysis and proactive management of high-volume traffic surges.

Based at least in part on identifying burst traffic, the traffic analysis code 116 may compute a mean cyclicity for burst traffic associated with a particular event (e.g., E2), where the mean cyclicity indicates an average interval between adjacent bursts. To illustrate, in the above scenario, the traffic analysis code 116 may compute that a mean cyclicity for E2-specific burst traffic in the third time interval t3 and the fourth time interval t4 is approximately one (1) hour (e.g., Mean Cyclicity (E2)~1 hour), which may enable the prediction of future occurrences of burst traffic (e.g., of interaction event type E2). Additionally, or alternatively, the traffic analysis code 116 may compute a burst traffic time variance metric for the same burst types, where the burst traffic time variance provides an indication of a spread and consistency of the burst traffic patterns over multiple bursts.

Alternatively, or additionally, the traffic analysis code 116 may monitor identified traffic patterns (e.g., burst traffic patterns) for a longer duration (e.g., one week) and may observe specific behaviors, such as bursts of traffic for an API endpoint. The traffic analysis code 116 may analyze the respective timestamps of the bursts of traffic, such as by computing the time intervals between consecutive bursts (e.g., the time elapsed from the end of one burst to the start of the next burst) and determining that the intervals between consecutive bursts of traffic vary slightly from an exact time (e.g., an exact time of 60 minutes). For example, the traffic analysis code 116 may compute a first interval of 58 minutes, a second interval of 62 minutes, a third interval of 59 minutes, and a fourth interval of 61 minutes. Using interaction data with an extended testing duration (e.g., one week), the traffic analysis code 116 may calculate a consecutive burst interval time variance and/or a consecutive burst interval time standard deviation for the intervals between consecutive bursts, resulting in a derived variance of 2 minutes. That is, the traffic analysis code 116 may compute that the intervals between consecutive bursts of traffic deviate by about 2 minutes from the average interval of one hour. The consecutive burst interval time variance and/or consecutive burst interval time standard deviation may be used to generate a prediction about future bursts of traffic (e.g., understanding the consistency of the burst traffic patterns).

As shown by FIG. 1F and reference number 122, the traffic analysis code 116 may generate a predicted second quantity or a predicted second scale of client-server interactions and/or predicted burst traffic behavior. In some aspects, the second quantity of client-server interactions and/or predicted burst traffic behavior may be based at least in part on a first quantity or a first scale of client-server interactions, such as the client-server interaction data 114 described with regard to FIG. 1C. For instance, the traffic analysis code 116 may compute a mean burst periodicity that predicts an average time interval between consecutive bursts of traffic. The traffic analysis code 116 may use any combination of one or more traffic characteristics, one or more traffic behavior metrics (e.g., burst density, time variance), historical data, and/or interaction data to compute mean burst periodicity. To illustrate, the traffic analysis code 116 may compute the mean burst periodicity by averaging the computed time intervals between consecutive bursts as described above (e.g., 58 minutes, 62 minutes, 59 minutes, and 61 minutes), resulting in a mean burst periodicity of 1 hour. The traffic analysis code 116 may use the mean burst periodicity to predict that bursts are likely to occur approximately every hour, and the prediction may be used to configure the server 102 to proactively allocate resources to handle the predicted traffic surges.

As another example, the traffic analysis code 116 may compute a predicted average number of TPS (e.g., transactions per second) during a burst. As an example, for the above scenario in which the burst density D=0.5 exceeds the burst density threshold T=0.3, and a burst time variance metric V=120 seconds, the traffic analysis code 116 may compute an average number of TPS as follows:

$$TPS = \frac{C \times D}{V}$$

A TPS metric may indicate a load on the server during burst traffic, and may be used to predict an amount of resources that the server 102 would use to handle the predicted traffic surges. That is, a TPS metric may be used to derive or predict a second quantity or a second scale of client interactions and, subsequently, a scale of server resources used to manage the anticipated traffic load.

As an example of using a TPS metric to derive or predict a second quantity or a second scale of client interactions, a published SLA for an event (e.g., E1, which may be an API event) may specify that, for the event, an operating condition to support 200 TPS with a mean response latency (e.g., the average time taken to process and respond to a request) of 400 milliseconds (msec) and a 90th percentile response latency of 2000 msec. A server's capacity to satisfy the operating condition at the 90th percentile, in terms of time per operation, may be calculated as the ratio of the latency to be met for the 90th percentile of requests to the number of requests per second for which the latency should be met. For example, in a scenario in which there are 200 requests per second, to meet an upper bound of a 2000 second latency for at least 90% of those requests (e.g., 200×90%), an amount of capacity at the server used to meet the SLA operating condition may be computed as:

$$\frac{2000}{( 200 * 90 \% )} = 11 msec per request$$

An average time per operation to satisfy the operating condition may be computed as:

$$\frac{400}{( 200 - 100 )} = 4 msec$$

In a similar manner, a capacity at the server to meet the mean SLA may be calculated as follows:

$$\frac{400}{( 200 * 50 \% )} = 4 msec$$

To illustrate, in order to satisfy the SLA operating condition of a 400 msec mean latency for a 200 TPS traffic condition, the server may need to service at least half of the requests (e.g., 200) within 400 msec, resulting in the server having a capacity to process each request within 4 msec.

In some aspects, the traffic analysis code 116 may scale a TPS computation from a first, smaller sample set (e.g., interaction data via the client devices 104) to a second quantity to validate whether the server 102 is capable of satisfying the operating condition of the SLA. To illustrate, each client-server interaction may be characterized as consuming a specific, finite amount of time and a specific, finite amount of resources (e.g., CPU cycles, memory usage), such that the time and resources are quantifiable and bounded (e.g., measured in milliseconds and megabytes), ensuring predictability in server load management. Using a bounded consumption model of interaction metrics enables the traffic analysis code 116 to accurately model and forecast server performance under varying traffic conditions, facilitating efficient resource allocation and/or facilitating configuring the server 102 to handle anticipated traffic surges without exceeding an operational capacity.

As an example of scaling a TPS computation, the traffic analysis code 116 may leverage a relationship between a first quantity of client devices (e.g., a quantity of the client devices 104) used to generate the interaction data, the burst density calculated from this smaller sample set, and the time interval over which interactions are averaged to predict an expected load at a second, larger scale (e.g., for a second quantity of client devices). That is, the traffic analysis code 116 may extrapolate the smaller-scale observations to evaluate a performance of the server 102 in full-scale deployment. For instance, based at least in part on a burst density of 0.5, a time variance of 120 seconds, and the above formula (e.g., TPS=(C×D)/120), the traffic analysis code 116 may compute (e.g., scale) TPS based on the number of clients. As an example, in a scenario for 1 million clients, the traffic analysis code 116 may compute a predicted TPS of:

$$\frac{1 , 000 , 000 \times 0.5}{120} = 4166.667 TPS$$

Comparing the predicted TPS to the SLA operating conditions, the traffic analysis code 116 may determine that the server 102 may lack resources to handle the increased traffic load and/or may indicate to configure the server 102 with additional resources to ensure compliance with the operating conditions of the SLA. The ability to compute burst TPS at a smaller scale and extrapolate the TPS to a larger scale may enable modifying a configuration of the server 102 to satisfy the operating conditions of the SLA under varying load conditions, evaluate whether a current server capacity and configurations are sufficient, or where to adjust resources at the server 102 to handle the increased traffic load.

Alternatively, or additionally, the traffic analysis code 116 may calculate expected transactions per minute at the traffic level indicated by the predicted burst conditions. For instance, based at least in part on the predicted TPS of 4167, the traffic analysis code 116 may predict a transactions per minute metric of approximately 250,020 for peak load conditions (e.g., periods when the server experiences maximum demand as indicated by the TPS). The traffic analysis code 116 may evaluate the predicted transactions per minute metric in view of the operating conditions of an SLA to identify potential points of traffic congestion, such as bottlenecks, that could impact server performance and user experience, and enable proactive configuration of the server 102 to ensure compliance with SLA requirements and maintain optimal service levels during high-traffic periods.

In some aspects, the traffic analysis code 116 may calculate a predicted average response latency using a predicted TPS during the burst traffic (e.g., the scaled TPS) using calculations performed as described above. For instance, the traffic analysis code 116 may multiply a scaled TPS (e.g., 4167) by an average time per operation (e.g., 4 msec) to compute a predicted response latency for the 50th percentile of the requests (e.g., 16.668 seconds). Alternatively, or additionally, the traffic analysis code 116 may compute a predicted 90th percentile response latency metric by calculating the product of the TPS and the time per operation at the 90th percentile (e.g., as specified by the SLA operating conditions), resulting in a predicted latency of 45 seconds for the 90th percentile of the requests (e.g., 4167×11 msec). The predicted 90th percentile response latency metric provides a measure of how the server 102 may handle high-intensity operations and may provide insight into potential response latency issues during peak traffic conditions. For instance, based at least in part on a client device timeout being set to 15 seconds, the response latency predictions may indicate that more than 50% of requests will timeout. Computing predictions as described herein may enable proactive modifications to the server 102, ensuring that the server 102 meets SLA operating conditions and maintains optimal performance levels, resulting in increased reliability (e.g., reduced request timeouts and reduced response times) during periods of maximum demand. Alternatively, or additionally, computing predictions may facilitate scaling resources at the server to increase server capacity to handle the predicted burst traffic, or alternatively a redesign of logic at a client device to mitigate the burst traffic behavior and match an available server capacity.

Other examples of detecting and managing burst traffic may include model-based approaches that leverage advanced algorithms to analyze client traffic as time series data. As an example, a probabilistic model for detecting bursts (e.g., Kleinberg's burst detection algorithm) may receive the interaction data generated by the client devices 104 and identify periods of unusually high activity or frequency within the data. An anomaly detection model may apply statistical techniques to the interaction data to detect anomalies in traffic patterns and identify deviations from expected behavior that may indicate the onset of burst traffic. A traffic anomaly detection model (e.g., a distributed denial of service (DDoS) detection algorithm) may detect and analyze network traffic patterns in the interaction data to detect anomalies such as sudden spikes in traffic volume, unusual traffic distribution, or unexpected changes in the types of requests, thereby helping to mitigate potential disruptions caused by high-volume traffic events.

As indicated above, FIGS. 1A-1F is provided as an example. Other examples may differ from what is described with regard to FIGS. 1A-1F.

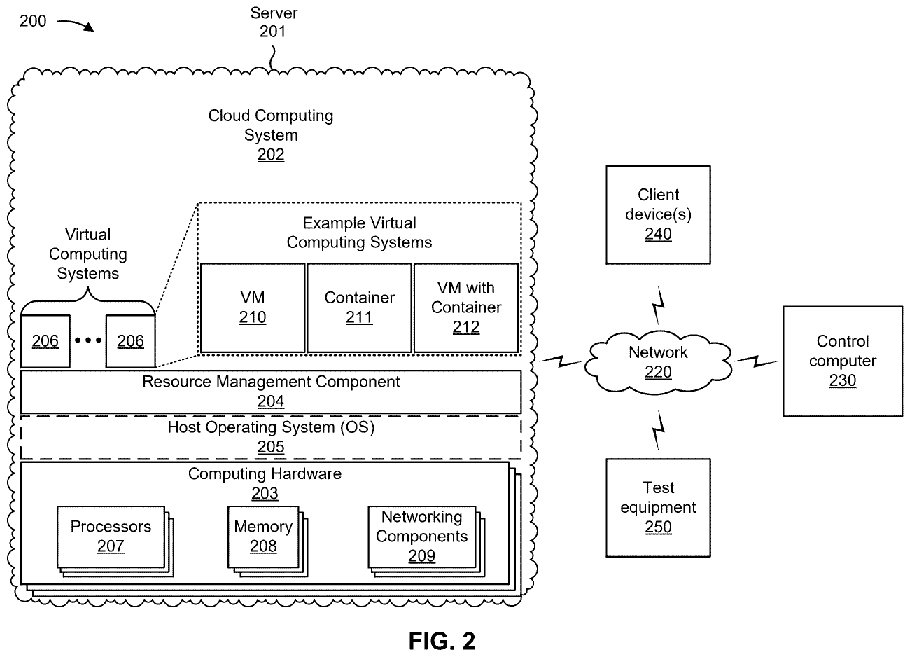

FIG. 2 is a diagram of an example environment 200 in which systems and/or methods described herein may be implemented. As shown in FIG. 2, environment 200 may include a server 201, which may include one or more elements of and/or may execute within a cloud computing system 202. The cloud computing system 202 may include one or more elements 203-212, as described in more detail below. As further shown in FIG. 2, environment 200 may include a network 220, a control computer 230, one or more client devices 240, and/or test equipment 250. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

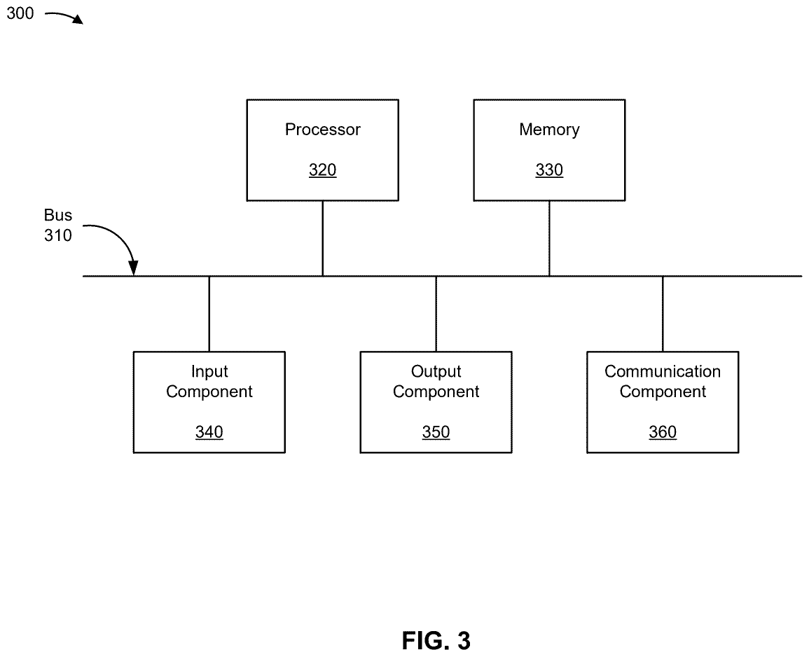

Although the server 201 may include one or more elements 203-212 of the cloud computing system 202, may execute within the cloud computing system 202, and/or may be hosted within the cloud computing system 202, in some implementations, the server 201 may not be cloud-based (e.g., may be implemented outside of a cloud computing system) or may be partially cloud-based. For example, the server 201 may include one or more devices that are not part of the cloud computing system 202, such as device 300 of FIG. 3, which may include a standalone server or another type of computing device. The server 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with predicting burst traffic at a server using scalable client interaction analysis. The device 300 corresponds to one or more of a server (e.g., the server 102), one or more client devices (e.g., the client devices 104), a control computer (e.g., the control computer 108), and/or test equipment (e.g., the test equipment 110). In some implementations, a server (e.g., the server 102), one or more client devices (e.g., the client devices 104), a control computer (e.g., the control computer 108), and/or test equipment (e.g., the test equipment 110) include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

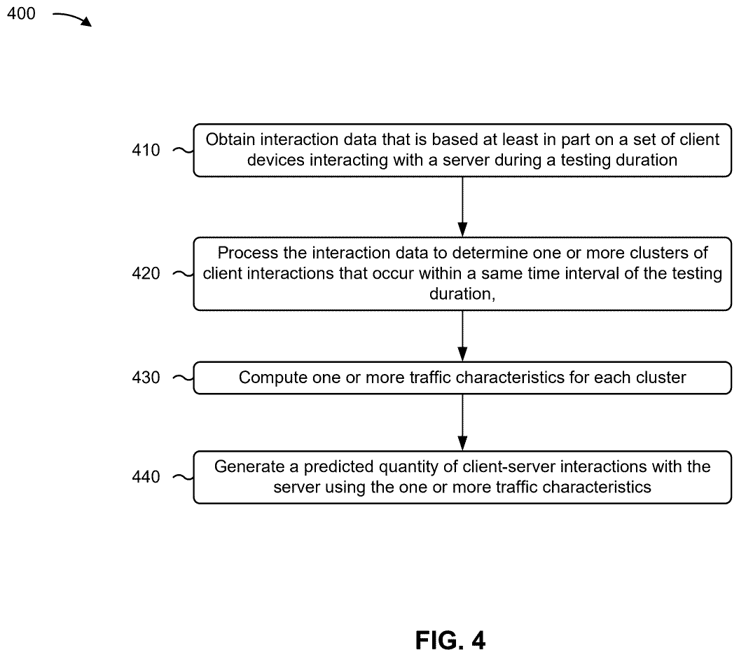

FIG. 4 is a flowchart of an example process 400 associated with predicting burst traffic at a server using scalable client interaction analysis. In some implementations, one or more process blocks of FIG. 4 may be performed by a computing device (e.g., control computer 108). In some implementations, one or more process blocks of FIG. 4 may be performed by another device or a group of devices separate from or including the computing device, such as a server (e.g., server 102), a client device (e.g., a client device 104), and/or test equipment (e.g., test equipment 110). Additionally, or alternatively, one or more process blocks of FIG. 4 may be performed by one or more components of device 300, such as processor 320, memory 330, input component 340, output component 350, and/or communication component 360.

As shown in FIG. 4, process 400 may include obtaining interaction data that is based at least in part on a set of client devices interacting with a server during a testing duration, the set of client devices associated with a first quantity or first scale of client-server interactions with the server (block 410). For example, the computing device may obtain interaction data that is based at least in part on a set of client devices interacting with a server during a testing duration, the set of client devices associated with a first quantity or first scale of client-server interactions with the server, as described above.

As further shown in FIG. 4, process 400 may include processing the interaction data to determine one or more clusters of client interactions that occur within a same time interval of the testing duration, each cluster of the one or more clusters being a respective potential high traffic load (block 420). For example, the computing device may process the interaction data to determine one or more clusters of client interactions that occur within a same time interval of the testing duration, each cluster of the one or more clusters being a respective potential high traffic load (e.g., an amount of traffic that satisfies a high traffic threshold), as described above.

As further shown in FIG. 4, process 400 may include computing one or more traffic characteristics for each cluster of the one or more clusters (block 430). For example, the computing device may compute one or more traffic characteristics for each cluster of the one or more clusters, as described above.

As further shown in FIG. 4, process 400 may include generating a predicted second quantity of client-server interactions with the server using the one or more traffic characteristics, the second quantity being larger than the first quantity (block 440). For example, the computing device may generate a predicted second quantity of client-server interactions with the server using the one or more traffic characteristics, the second quantity being larger than the first quantity, as described above.

In some implementations, each client-server interaction of the second quantity of client-server interactions includes a client request to the server for a specific service that consumes a first finite amount of time and a second finite amount of resources at the server. Alternatively, or additionally, each client interaction of the first quantity of client interactions has a respective timestamp and a respective event type. In some cases, processing the interaction data includes ordering the client interactions by respective timestamps and respective event types and determining the cluster(s) of client interactions by grouping client interactions (e.g., of the first quantity of client interactions) that have a same respective event type and occur within a same respective time interval of the testing duration into a same cluster. Processing the interaction data includes computing a respective quantity of client interactions in each cluster of the one or more clusters, and classifying each cluster of the one or more clusters that has the respective quantity of client interactions satisfying a traffic load threshold as the respective potential high traffic load.

Grouping client interactions of the first quantity or the first scale of client interactions may include rounding the respective timestamp of each client interaction of the first quantity or the first scale of client interactions to a nearest time interval, and grouping the client interactions into a respective cluster (e.g., of the one or more clusters) that is associated with the nearest time interval. Process 400 may include classifying each respective cluster of the one or more clusters as a burst traffic type, the burst traffic type being at least one of a multi-client burst traffic type, a single-client burst traffic type, or a global burst traffic type. The respective event type of each client interaction may include at least one of a fetch request, an event-triggered request, an operational request, a service-specific request, or an application programming interface call.

Alternatively, or additionally, computing the one or more traffic characteristics for each cluster of the one or more clusters may include analyzing the interaction data to derive the traffic characteristic(s). The traffic characteristic(s) for each cluster may include a burst density of the cluster, a quantity of client interactions in the cluster, a burst time variance metric for the quantity of client interactions in the cluster, a TPS of the cluster, a periodicity of burst traffic in the cluster, or a statistical metric of the cluster, or any combination thereof.

Process 400 may include analyzing the one or more respective traffic characteristics to derive one or more traffic behavior trends. In some cases, the traffic behavior trend(s) may include a recurrence of an event-specific high traffic load (e.g., an amount of traffic that satisfies a high traffic threshold), a statistical metric of the event-specific high traffic load, a burst periodicity of the event-specific high traffic load, a burst density of the event-specific high traffic load, a predicted transactions per minute metric for a burst of the event-specific high traffic load, a predicted latency for the burst of the event-specific high traffic load, a predicted client timeout during the burst of the event-specific high traffic load, or any combination thereof. Computing the one or more traffic characteristics for each cluster may include classifying the cluster as a multi-client burst traffic type based on analyzing request data in the interaction data. In some cases, the request data is a timestamp, a request endpoint, a request header, a request body, device information, account information, or any combination.

Computing the one or more respective traffic characteristics for each cluster of the one or more clusters may include deriving a cyclical pattern of burst traffic that satisfies a high traffic threshold based on analyzing the interaction data, and computing one or more statistical metrics using the cyclical pattern, the statistical metric(s) including at least one of a variance in a timing of the burst traffic, a minimum percentage of clients contributing to the burst traffic, or a maximum percentage of clients contributing to the burst traffic. Alternatively, or additionally, computing the traffic characteristic(s) for each cluster includes deriving a predicted point of communication congestion at the server for handling the client-server interactions. Deriving the predicted point of communication congestion may be based on analyzing the interaction data, where the interaction data indicates a burst traffic pattern, a server performance metric, or both.

Analyzing the interaction data may include determining, from the interaction data, a periodic occurrence of burst traffic with a volume that satisfies a high traffic threshold. Alternatively, or additionally, analyzing the interaction data may include calculating, from the interaction data, a variance in a timing of the burst traffic and identifying, from the interaction data, a minimum percentage of client devices in the set of client devices contributing to the burst traffic. In some cases, analyzing the interaction data includes identifying, from the interaction data, a maximum percentage of client devices in the set of client devices contributing to the burst traffic loads.

Process 400 may include detecting burst activity within the first quantity of client-server interactions using a burst detection algorithm. Generating the predicted second quantity of client-server interactions with the server using the traffic characteristic(s) may include determining a respective burst density for each cluster of the one or more clusters, and calculating a predicted number of client interactions for the second quantity based on the respective burst density and a total number of clients in the second quantity. In some cases, process 400 includes simulating the client-server interactions at the second quantity using the predicted number of client interactions to generate simulated interaction data, and computing one or more server performance metrics using the simulated interaction data.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limited to the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
obtaining interaction data that is based on a set of client devices interacting with a server during a testing duration, the set of client devices associated with a first quantity of client-server interactions with the server;
processing the interaction data to determine one or more clusters of client interactions that occur within a same time interval of the testing duration, each cluster of the one or more clusters being a respective potential high traffic load;
computing one or more traffic characteristics for each cluster of the one or more clusters; and
generating a predicted second quantity of client-server interactions with the server using the one or more traffic characteristics, the second quantity being larger than the first quantity.

2. The method of claim 1, wherein each client-server interaction of the second quantity of client-server interactions comprises a client request to the server for a specific service that consumes a first finite amount of time and a second finite amount of resources at the server.

3. The method of claim 1, wherein each client interaction of the first quantity of client interactions has a respective timestamp and a respective event type, and wherein processing the interaction data comprises:
ordering the client interactions by respective timestamps and respective event types;
determining the one or more clusters by grouping each client interaction of the first quantity of client interactions that have a same respective event type and occur within a same respective time interval of the testing duration into a same cluster;
computing a respective quantity of client interactions in each cluster of the one or more clusters; and
classifying each cluster of the one or more clusters that has the respective quantity satisfying a traffic load threshold as the respective potential high traffic load.

4. The method of claim 3, wherein grouping each client interaction of the first quantity of client interactions comprises:
rounding the respective timestamp of each client interaction of the first quantity of client interactions to a nearest time interval; and
grouping the client interaction into a respective cluster, of the one or more clusters, that is associated with the nearest time interval.

5. The method of claim 3, further comprising:
classifying each respective cluster of the one or more clusters as a burst traffic type, the burst traffic type being at least one of:
a multi-client burst traffic type,
a single-client burst traffic type, or
a global burst traffic type.

6. The method of claim 3, wherein the respective event type comprises at least one of:
a fetch request,
an event-triggered request,
an operational request,
a service-specific request, or
an application programming interface call.

7. The method of claim 1, wherein computing the one or more respective traffic characteristics for each cluster of the one or more clusters comprises:
analyzing the interaction data to derive the one or more respective traffic characteristics.

8. The method of claim 7, wherein the one or more respective traffic characteristics for each cluster comprise at least one of:
a burst density of the cluster,
a quantity of client interactions in the cluster,
a burst time variance metric for the quantity of client interactions in the cluster,
a peak transactions per second (TPS) of the cluster,
a periodicity of burst traffic in the cluster, or
a statistical metric of the cluster.

9. The method of claim 7, further comprising:
analyzing the one or more respective traffic characteristics to derive one or more traffic behavior trends.

10. The method of claim 9, wherein the one or more traffic behavior trends comprise at least one of:
a recurrence of an event-specific high traffic load,
a statistical metric of the event-specific high traffic load,
a burst periodicity of the event-specific high traffic load,
a burst density of the event-specific high traffic load,
a predicted transactions per minute metric for a burst of the event-specific high traffic load,
a predicted latency for the burst of the event-specific high traffic load, or
a predicted client timeout during the burst of the event-specific high traffic load.

11. The method of claim 1, wherein computing the one or more respective traffic characteristics for each cluster of the one or more clusters comprises:
classifying at least one cluster of the one or more clusters as a multi-client burst traffic type based on analyzing request data in the interaction data, wherein the request data comprises at least one of:
a timestamp,
a request endpoint,
a request header,
a request body,
device information, or
account information.

12. A device, comprising:
one or more processors configured to:
obtain interaction data that is based at least in part on a set of client devices interacting with a server during a testing duration, the set of client devices associated with a first quantity of client-server interactions with the server;
process the interaction data to determine one or more clusters of client interactions that occur within a same time interval of the testing duration, each cluster of the one or more clusters being a respective potential high traffic load;
compute one or more respective traffic characteristics for each cluster of the one or more clusters; and
predict a second quantity of client-server interactions with the server using the one or more respective traffic characteristics, the second quantity being larger than the first quantity.

13. The device of claim 12, wherein the one or more processors, to compute the one or more respective traffic characteristics for each cluster of the one or more clusters, are configured to:
derive a predicted point of communication congestion at the server for handling the client-server interactions based on analyzing the interaction data, wherein the interaction data indicates at least one of:
a traffic pattern, or
a server performance metric.

14. The device of claim 13, wherein the one or more processors, to analyze the interaction data, are configured to:
determine, from the interaction data, a periodic occurrence of traffic loads that satisfy a high traffic threshold;
calculate, from the interaction data, a variance in a timing of the traffic loads that satisfy the high traffic threshold;
identify, from the interaction data, a minimum percentage of client devices in the set of client devices contributing to the traffic loads that satisfy the high traffic threshold; and
identify, from the interaction data, a maximum percentage of client devices in the set of client devices contributing to the traffic loads that satisfy the high traffic threshold.

15. The device of claim 12, wherein the one or more processors are configured to:
detect, using the interaction data, burst activity within the first quantity of client-server interactions using a burst detection algorithm.

16. The device of claim 12, wherein the one or more processors, to compute the one or more respective traffic characteristics for each cluster of the one or more clusters, are configured to:
derive a cyclical pattern of traffic loads that satisfy a high traffic threshold based on analyzing the interaction data; and
compute one or more statistical metrics using the cyclical pattern, the one or more statistical metrics comprising at least one of:
a variance in a timing of the traffic loads that satisfy the high traffic threshold,
a minimum percentage of clients contributing to the traffic loads that satisfy the high traffic threshold, or
a maximum percentage of clients contributing to the traffic loads that satisfy the high traffic threshold.

17. The device of claim 12, wherein each client interaction of the first quantity of client interactions has a respective timestamp and a respective event type, and
wherein the one or more processors, to process the interaction data are configured to:
order the client interactions by respective timestamps and respective event types;
determine the one or more clusters by grouping each client interaction of the first quantity of client interactions that have a same respective event type and occur within a same respective time interval of the testing duration;
compute a respective quantity of client interactions in each cluster of the one or more clusters; and
classify a respective cluster of the one or more clusters as the respective potential high traffic load based on the respective quantity of client interactions satisfying a traffic load threshold.

18. The device of claim 12, wherein the one or more processors, to generate the predicted second quantity of client-server interactions with the server using the one or more respective traffic characteristics, are configured to:
determine a respective burst density for each cluster of the one or more clusters; and
calculate a predicted number of client interactions for the second quantity based on the respective burst density and a total number of clients in the second quantity.

19. The device of claim 18, wherein the one or more processors are configured to:
simulate the client-server interactions at the second quantity using the predicted number of client interactions to generate simulated interaction data; and
compute one or more server performance metrics using the simulated interaction data.

20. A non-transitory computer-readable medium storing a set of instructions, the set of instructions comprising:
one or more instructions that, when executed by one or more processors of a device, cause the device to:
obtain interaction data that is based at least in part on a set of client devices interacting with a server during a testing duration, the set of client devices associated with a first quantity of client-server interactions with the server;
process the interaction data to determine one or more clusters of client interactions that occur within a same time interval of the testing duration, each cluster of the one or more clusters being a respective potential high traffic load;
compute one or more respective traffic characteristics for each cluster of the one or more clusters; and
generate a predicted second quantity of client-server interactions with the server using the one or more respective traffic characteristics, the second quantity being larger than the first quantity.
